(19) United States
(12) Patent Application Publication
(10) Pub. No.: US 2010/0231423 A1
(43) Pub. Date: Sep. 16, 2010

(54) KEYBOARD

(75) Inventor: SONG-LING YANG, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/468,812

(22) Filed: May 19, 2009

(30) Foreign Application Priority Data
Mar. 10, 2009 (CN) 200910300770.7

(51) Int. Cl. H01H 13/70; H01F 7/02

(52) U.S. Cl. 341/32; 200/344; 335/302

(57) ABSTRACT

A magnetic induction keyboard that can also be used as a charger for rechargeable batteries.

### BACKGROUND

1. Technical Field

The present disclosure relates to keyboards, and particularly, to a keyboard using electromagnetic induction to detect a keystroke.

2. Description of Related Art

Keyboards typically include a circuit board and a number of keys disposed on the circuit board. Each of the keys includes a bottom facing to the circuit board, and a stem extending from the bottom. The circuit board forms a number of electrical switches corresponding to each of the keys. When a key is depressed, the stem touches the corresponding switch, a corresponding input signal is triggered. Repeated contact of the stem with the electrical switches wears out the electrical switches and this reduces the lifetime of the keyboard.

What is needed, therefore, is a keyboard which can overcome the above-mentioned problems.

### BRIEF DESCRIPTION OF THE DRAWINGS

Many aspects of the present embodiments can be understood with reference to the figures. The components in the figures are not necessarily drawn to scale, the emphasis instead being placed upon clearly illustrating the principles of the present embodiments. Moreover, in the figures, like reference numerals designate corresponding parts throughout the several views.

FIG. 1 is an isometric, schematic view of a keyboard in accordance with a first embodiment.

FIG. 2 is an isometric, schematic view of a resilient element of a key of the keyboard of FIG. 1.

FIG. 3 is an isometric, schematic view of a resilient element and a support sheet of the keyboard of FIG. 1.

FIG. 4 is an isometric, schematic view of a keyboard in accordance with a second embodiment.

### DETAILED DESCRIPTION

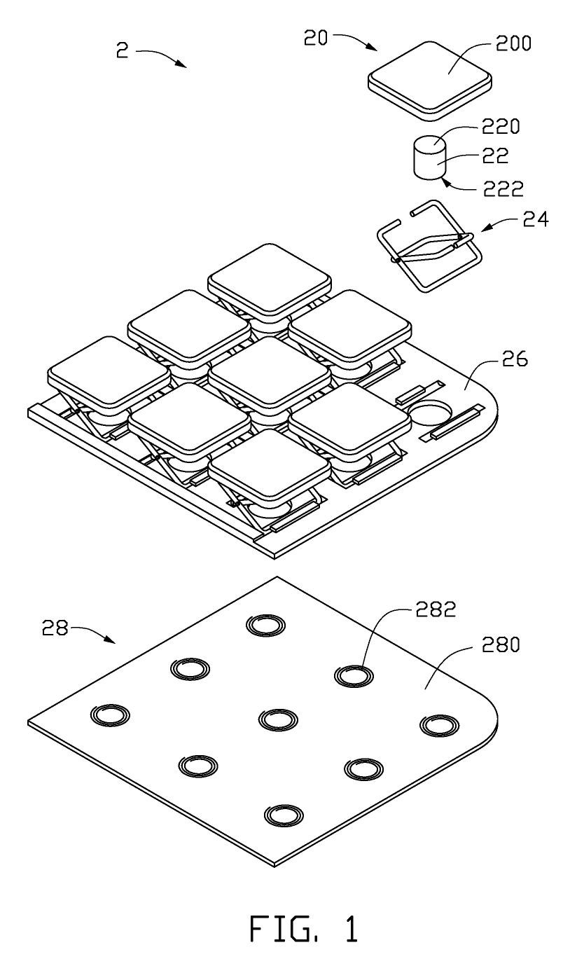

Referring to FIG. 1, a keyboard 2 in accordance with a first embodiment is disclosed. The keyboard 2 includes a number of keys 20, a number of magnetic elements 22, a number of resilient elements 24, a support sheet 26, and a sensing board 28.

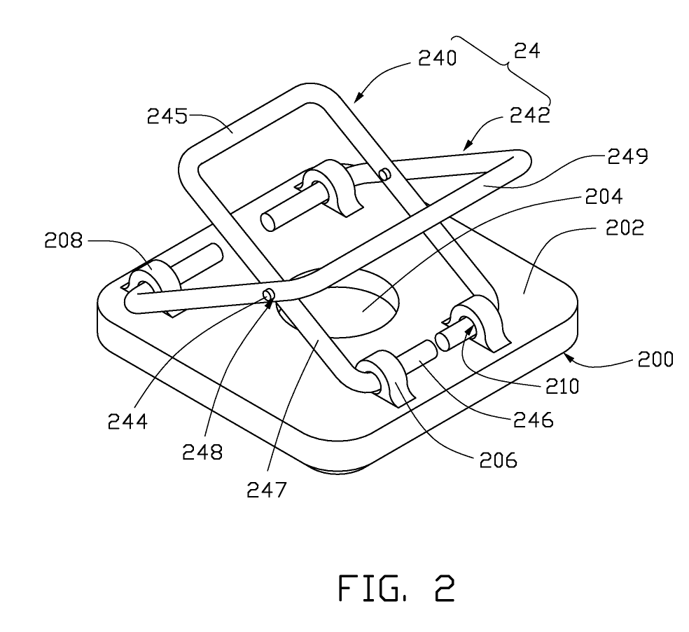

Also referring to FIG. 2, each of the keys 20 is rectangular and includes an upper surface 200 for pressing, an opposite bottom surface 202, a pair of first joining members 206, and a pair of second joining members 208. A blind hole 204 is defined in the bottom surface 202. The first joining members 206 and the second joining members 208 are formed on the bottom surface 202. Each of the first joining members 206 and second joining members 208 are substantially similar to each other in shape and each is semi-cylindrical extending upwards from the bottom surface 202 and defines a pivot hole 210 therethrough. The pivot holes 210 of the first joining members 206 are aligned with each other. The pivot holes 210 of the second joining members 208 are aligned with each other.

The resilient element 24 includes a first supporting rack 240, a second supporting rack 242, and a pair of fastening members 244. The first supporting rack 240 is rectangular. The first supporting rack 240 includes a middle portion 245, two side portions 247, and two ends 246. The two side portions 247 extend from two ends of the middle portion 245 correspondingly and are substantially perpendicular to the middle portion 245. The ends 246 extend from the two side portions 247 correspondingly towards each other and are substantially perpendicular to the side portions 247. Each of the side portions 247 defines a joining hole 248 in the middle. The two joining holes 248 are aligned with each other. The second supporting rack 242 is substantially similar to the first supporting rack 240 in shape and includes the counterparts of the first supporting rack 240.

The length of the middle portion 245 of the first supporting rack 240 is a little greater than the distance between the first joining members 206 and the length of a middle portion 249 of the second supporting rack 242 is a little greater than the distance between the second joining members 208. The first supporting rack 240 and the second supporting rack 242 are coupled to each other by inserting the fastening member 244 through the corresponding joining holes 248. The first supporting rack 240 and the second supporting rack 242 should be made of resilient material.

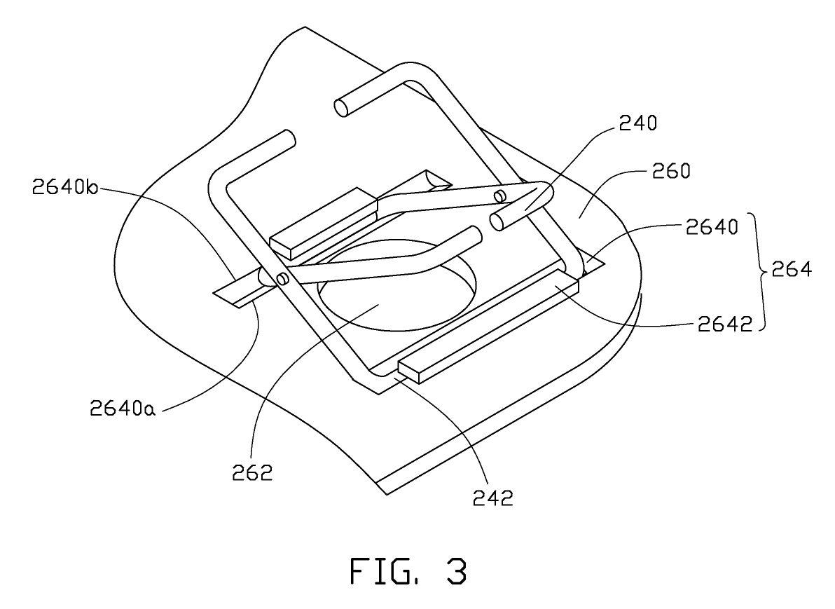

Also referring to FIG. 3, the support sheet 26 includes a connecting surface 260, a matrix of through holes 262, and a number of limiting members 264 disposed on the connecting surface 260. Each of the limiting members 264 includes two parallel slots 2640 and two limiting blocks 2642 corresponding to the slots 2640. The slots 2640 are defined on the connecting surface 260 at opposite sides of the through hole 262. Each of the slots 2640 is bounded by an inner edge 2640a near to the through hole 262 and an outer edge 2640b away from the through hole 262. The limiting blocks 2642 are fixed at the outer edges 2640b correspondingly and partially cover the slots 2640. The support sheet 26 can be made of non-magnetic material to avoid magnetic interference with the magnetic element 22.

The magnetic element 22 is cylindrical and includes an upper end 220 having a first magnetic polarity and a bottom end 222 having a second magnetic polarity opposite to the first magnetic polarity. The magnetic polarity direction of the magnetic elements 22 is perpendicular to the sensing board 28.

The sensing board 28 includes a sensing surface 280 and a matrix of induction coils 282. The sensing board 28 can be a printed circuit board with the induction coils 282 etched thereon.

In assembly, the magnetic elements 22 are fixed in the blind holes 204 of the keys 20 correspondingly. The first and second supporting racks 240, 242 are rotatablely connected to the key 20 via rotatably inserting the ends 246 through the pivot holes 210 of the first and second joining members 206, 208 correspondingly. The first and second supporting racks 240, 242 are rotatablely connected to the support sheet 26 via the middle portions 245, 249 accommodated in the slots 2640 and limited by the limiting blocks 2642. The through holes 262 of the support sheet 26 are aligned with the magnetic elements 22 fixed in the keys 20 correspondingly. The sensing board 28 is disposed beneath the support sheet 26 with the induction coils 282 aligned with the through holes 262 of the support sheet 26 correspondingly.

In use, when the key 20 is pressed, the first and second supporting racks 240, 242 deforms, the magnetic element 22 moves towards the corresponding induction coil 282. The induction coil 282 corresponding to the pressed key 20 generates induced current. The coordinate of the pressed key 20 can be known by sensing the induced current of the induction coil 282.

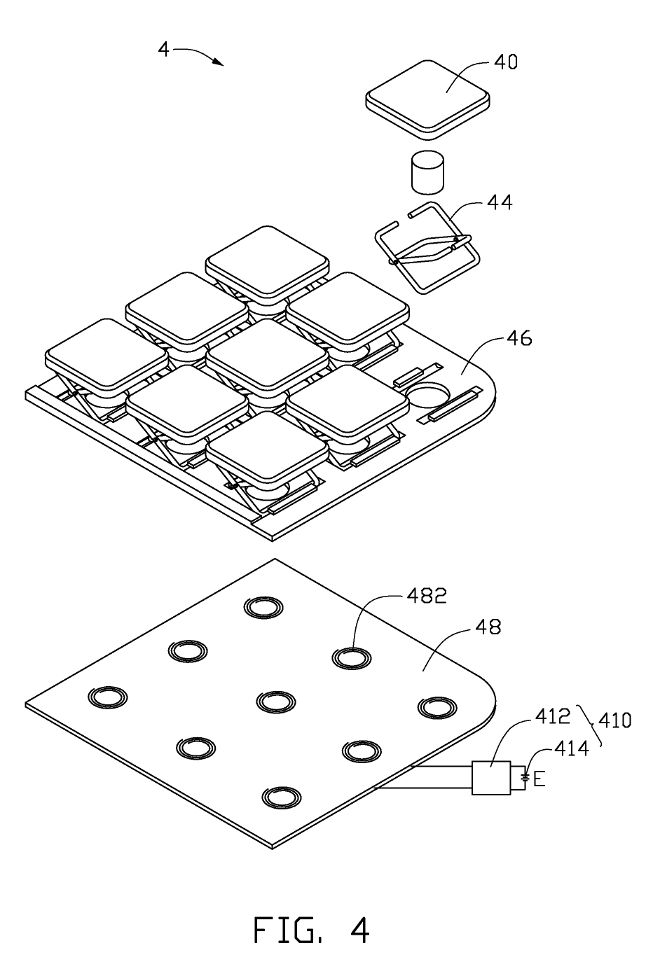

Referring to FIG. 4, a keyboard 4 in accordance with a second embodiment is similar to that of the first embodiment except that the keyboard 4 further includes an energy storage device 410 for storing the electrical energy generated by the induction coils 482.

The energy storage device 410 includes a charge pump 412 and a battery 414. The charge pump 412 is connected to the sensing board 48 and the battery 414 is connected to the charge pump 412. Each of the induction coils 482 corresponding to the pressed keys 40 can be represented as a generator. The collective induced current outputted from the induction coils 482 are provided to the charge pump 412. The charge pump 412 in turn amasses the induced current generated by the induction coils 482 for charging the battery 414.

It should be mentioned that the resilient element 44 can be any other form/configuration that can still connect the key 40 and the support sheet 46 to restore the key 40 after the key 40 is pressed towards the support sheet 46 and released. For example, the resilient element 44 can be a spring.

The keyboard 4 uses electromagnetic induction to detect the pressed key 40 of the keyboard 4 without mechanical contact between the key 40 and the sensing board 48. The damage caused by the mechanical contact can be avoided. Therefore, the keyboard 4 is more durable. Otherwise, the induced current generated by the induction coils 482 can be collected by the charge pump 412 for charging the battery 414.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A keyboard comprising:
a key;
a magnetic element fixed in the key;
a support sheet;
a resilient element connecting the key and the support sheet to restore the key after the key is pressed towards the support sheet and released;
a sensing board disposed beneath the support sheet; and
an induction coil mounted on the sensing board and aligned with the magnetic element to generate an electrical signal when the key is pressed.

2. The keyboard as claimed in claim 1, wherein the key comprises an upper surface for being pressed, an opposite bottom surface, a blind hole, a pair of first joining members, and a pair of second joining members; the blind hole, the first joining member, and the second joining member are defined on the bottom surface; the magnetic element is fixed in the blind hole; the support sheet comprises a connecting surface, a through hole, and a limiting member disposed on the connecting surface; the resilient member comprises a first supporting rack, a second supporting rack and a pair of fastening members; the first supporting rack and the second supporting rack are coupled to each other by the fastening members; the first supporting rack is rotatablely connected to the first joining member by one end and rotatablely connected to the limiting member by the other end, and the second supporting rack is rotatablely connected to the second joining member by one end and rotatablely connected to the limiting member by the other end.

3. The keyboard as claimed in claim 2, wherein each of the first and second joining members is semi-cylindrical extending from the bottom surface and defines a pivot hole therethrough.

4. The keyboard as claimed in claim 3, wherein each of the first and second supporting racks is rectangular in shape and comprises a middle portion, two side portions, and two ends, the two side portions extended from two ends of the middle portion correspondingly and being substantially perpendicular to the middle portion, the ends extended from the two side portions correspondingly towards each other and being substantially perpendicular to the side portions; each of the side portions defines a joining hole at the middle thereof, the joining holes aligned with each other; the first supporting rack and the second supporting rack are coupled to each other by inserting a fastening member through the joining holes correspondingly; and the first and second supporting racks are rotatablely connected to the key via rotatably inserting the ends through the pivot holes.

5. The keyboard as claimed in claim 2, wherein the limiting member comprises two parallel slots and two limiting blocks corresponding to the slots, the slots defined on the connecting surface at opposite sides of the through hole; and each of the slots is bounded by an inner edge near to the through hole and an outer edge away from the through hole, the limiting blocks fixed at the outer edge correspondingly and partially covering the slots.

6. The keyboard as claimed in claim 1, wherein the magnetic element is cylindrical and comprises an upper end having a first magnetic polarity and a bottom end having a second magnetic polarity opposite to the first magnetic polarity, the magnetic polarity direction of the magnetic element being perpendicular to the sensing board.

7. The keyboard as claimed in claim 1, wherein the support sheet can be made of non-magnetic material.

8. A system for generating electrical energy, the system comprising:
a plurality of keys;
a plurality of magnetic elements fixed in each of the keys;
a support sheet;
a plurality of resilient elements connected to each of the keys and the support sheet for providing a return action of the keys;
a printed circuit board disposed beneath the support sheet; and
a plurality of induction coils mounted on the printed circuit board and aligned with each of the magnetic elements for generating electrical energy when the key is pressed; and
an energy storage device connected to the printed circuit board for storing the electrical energy generated by the induction coils.

9. The system as claimed in claim 8, wherein the key comprises an upper surface for being pressed, an opposite bottom surface, a blind hole, a pair of first joining members, and a pair of second joining members; the blind hole, the first joining member, and the second joining member are defined on the bottom surface; the magnetic element is fixed in the blind hole; the support sheet comprises a connecting surface, a plurality of through holes, and a plurality of limiting members disposed on the connecting surface; the resilient member comprises a first supporting rack, a second supporting rack and a pair of fastening members; the first supporting rack and the second supporting rack are coupled to each other by the fastening members; the first supporting rack is rotatablely connected to the first joining member by one end and rotatablely connected to the limiting member by the other end, and the second supporting rack is rotatablely connected to the second joining member by one end and rotatablely connected to the limiting member by the other end.

10. The system as claimed in claim 9, wherein each of the first and second joining members is semi-cylindrical extending from the bottom surface and defines a pivot hole therethrough.

11. The system as claimed in claim 9, wherein each of the first and second supporting racks is rectangular in shape and comprises a middle portion, two side portions, and two ends, the two side portions extended from two ends of the middle portion correspondingly and being substantially perpendicular to the middle portion, the ends extended from the two side portions correspondingly towards each other and being substantially perpendicular to the side portions; each of the side portions defines a joining hole at the middle thereof, the joining holes aligned with each other; the first supporting rack and the second supporting rack are coupled to each other by inserting the fastening member through the joining holes correspondingly; and the first and second supporting racks are rotatablely connected to the key via rotatably inserting the ends through the pivot holes.

12. The system as claimed in claim 9, wherein each of the limiting members comprises two parallel slots and two limiting blocks corresponding to the slots, the slots defined on the connecting surface at opposite sides of the through hole; and each of the slots is bounded by an inner edge near to the through hole and an outer edge away from the through hole, the limiting blocks fixed at the outer edge correspondingly and partially covering the slots.

13. The system as claimed in claim 8, wherein the magnetic element is cylindrical and comprises an upper end having a first magnetic polarity and a bottom end having a second magnetic polarity opposite to the first magnetic polarity, the magnetic polarity direction of the magnetic element being perpendicular to the sensing board.

14. The system as claimed in claim 8, wherein the support sheet can be made of non-magnetic material.

15. The system as claimed in claim 8, wherein the energy storage device comprises a charge pump connected to the printed circuit board and a battery connected to the charge pump, the charge pump amassing the electrical power generated by each of the induction coils for charging the battery.
